(19) United States
(12) Patent Application Publication
(10) Pub. No.: US 2016/0007199 A1
(43) Pub. Date: Jan. 7, 2016

(54) METHOD AND APPARATUS FOR CONTROLLING A DEVICE

(71) Applicant: NOKIA TECHNOLOGIES OY, Espoo (FI)

(72) Inventor: Jari MONONEN, RUUTANA (FI)

(73) Assignee: Nokia Technologies Oy

(21) Appl. No.: 14/772,370

(22) PCT Filed: Mar. 6, 2013
(86) PCT No.: PCT/FI2013/050243

§ 371 Date: Sep. 2, 2015

(51) Int. Cl. H04W 12/08; H04B 1/3816; H04M 3/38; H04W 12/06

(52) U.S. Cl. CPC H04W 12/08; H04W 12/06; H04B 1/3816; H04M 3/387

(57) ABSTRACT

In accordance with an example embodiment of the present invention, there is provided an apparatus, comprising a memory configured to store a time parameter defining a locking period, processing circuitry configured to determine, using the time parameter, whether the locking period has elapsed, the processing circuitry being further configured to, responsive to a determination that the locking period has elapsed, cause a locking feature to be disabled, wherein the locking feature is, when enabled, configured to restrict use of the apparatus to use with identity modules of a first type. The locking period may comprise an exclusivity period. The identity module may comprise a subscriber identity module.

### TECHNICAL FIELD

The present application relates generally to controlling a device, such as a subscriber unit.

### BACKGROUND

Cellular communication networks are operated by cellular operators. A cellular operator may have obtained, prior to installing or starting up his network, a license to use a segment of the electromagnetic spectrum for cellular communications, for example for use in cellular communications using a cellular standard, such as for example global system for mobile communication, GSM, wideband code division multiple access, WCDMA, or long term evolution, LTE. Licenses may be administered by authorities tasked with managing spectrum resources.

A cellular operator may provide cellular mobiles to subscribers for use with the operator's network. Alternatively, subscribers can purchase mobiles and subscriptions to a cellular network separately. In some cellular standards, a removable identity module may be installed in a mobile, to thereby configure the mobile to attach to and use a specific network defined in the identity module. An example of such an identity module is a subscriber identity module, SIM. If a cellular operator wishes to subsidize purchases of mobiles for subscribers, the operator may desire to lock the subsidized mobile to use only his network, as otherwise the utility of the subsidy would be lost to the operator.

In connection with purchasing a subsidized mobile from an operator, a subscriber may agree to use the mobile exclusively with the operator's network. This may entail configuring the mobile so it will only accept identity modules issued by the operator. The exclusivity may be limited, for example geographically or temporally. Where the exclusivity is limited temporally, that is to say it the subscriber agrees to an exclusivity time period, the subscriber may after the exclusivity time period expires bring his mobile to service to have the exclusivity feature deactivated by the operator.

### SUMMARY

Various aspects of examples of the invention are set out in the claims.

According to a first aspect of the present invention, there is provided an apparatus, comprising a memory configured to store a time parameter defining a locking period, processing circuitry configured to determine, using the time parameter, whether the locking period has elapsed, the processing circuitry being further configured to, responsive to a determination that the locking period has elapsed, cause a locking feature to be disabled, wherein the locking feature is, when enabled, configured to restrict use of the apparatus to use with identity modules of a first type.

According to a second aspect of the present invention, there is provided a method, comprising storing, in an apparatus, a time parameter defining a locking period, determining, using the time parameter, whether the locking period has elapsed, causing a locking feature to be disabled responsive to a determination that the locking period has elapsed, wherein the locking feature is, when enabled, configured to restrict use of the apparatus to use with identity modules of a first type.

According to a third aspect of the present invention, computer programs are provided, the computer programs being configured to cause methods in accordance with the second aspect to be performed.

### BRIEF DESCRIPTION OF THE DRAWINGS

For a more complete understanding of example embodiments of the present invention, reference is now made to the following descriptions taken in connection with the accompanying drawings in which:

FIG. 1 illustrates an example system capable of supporting at least some embodiments of the invention;

FIG. 2 illustrates a block diagram of an apparatus in accordance with an example embodiment of the invention;

FIG. 3 is a signaling diagram illustrating signaling in accordance with at least one embodiment of the invention; and

FIG. 4 is a flow diagram illustrating a method in accordance with at least some embodiments of the invention.

### DETAILED DESCRIPTION OF THE DRAWINGS

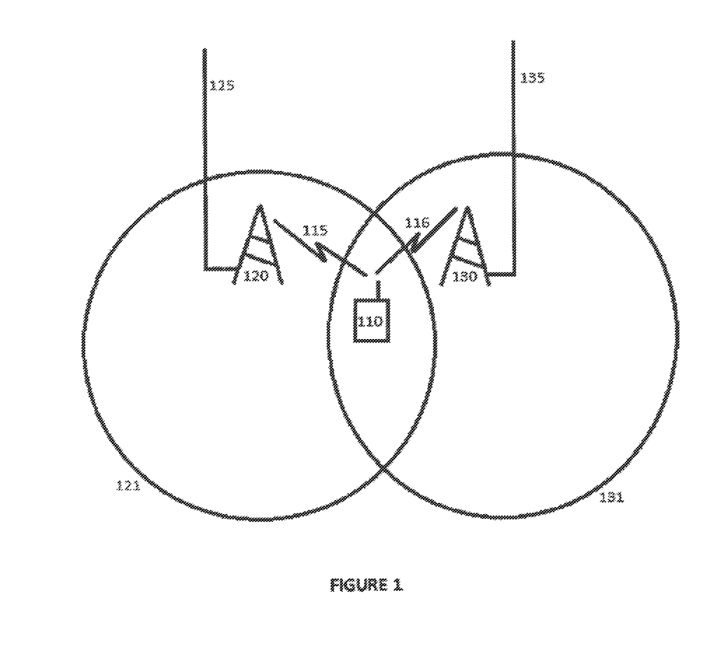

An example embodiment of the present invention and its potential advantages are understood by referring to FIGS. 1 through 4 of the drawings.

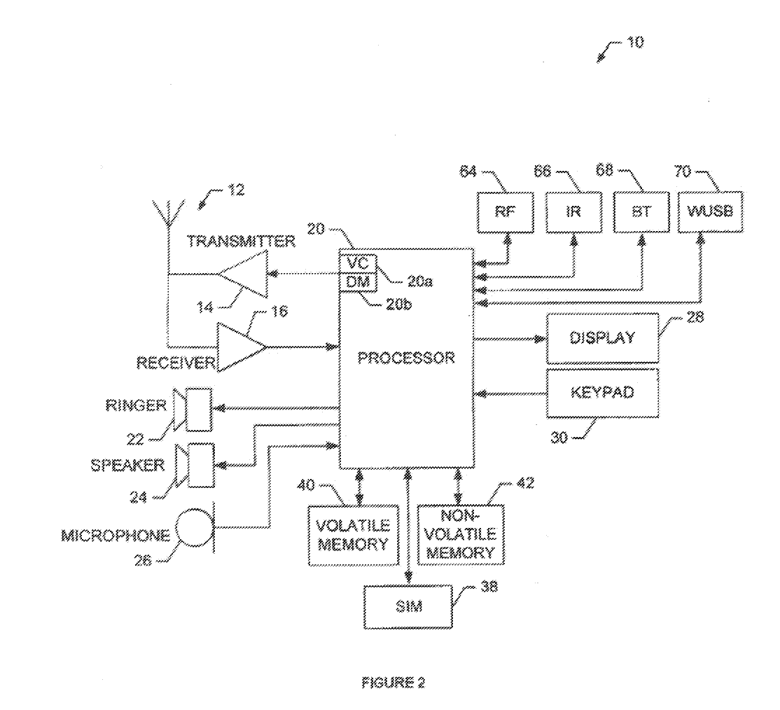

FIG. 1 illustrates an example system capable of supporting at least some embodiments of the invention. Illustrated is mobile 110, which may comprise, for example, a user equipment, cellular telephone, laptop computer, tablet computer, personal digital assistant, PDA, or other mobile device with connectivity functions. An example of structure of mobile 110 is presented in FIG. 2. Mobile 110 is illustrated as being disposed in a cell coverage area of cell 121, which is controlled by base station 120. Mobile 110 is also illustrated as being disposed in a cell coverage area of cell 131, which is controlled by base station 130. Base station 120 may comprise a base station of a first cellular network of a first cellular operator. Base station 130 may comprise a base station of a second cellular network of a second cellular operator. The first and second cellular networks may be configured to act in accordance with cellular standards, such as for example GSM, WCDMA or LTE. The first and second networks may be configured to use the same cellular standard, or alternatively they may be configured to use different cellular standards.

In FIG. 1, base station 120 is illustrated as being in communication with further nodes of the first cellular network via connection 125, which may comprise a wire-line or at least in part wireless connection. Such further nodes may comprise, for example, base station controllers, further base stations of the first cellular network or core network nodes. Core network nodes may comprise, for example, switches, gateways, subscriber information database nodes and mobility management entities. Similarly, base station 130 is illustrated as being in communication with further nodes of the second cellular network via connection 135, which may comprise a wire-line or at least in part wireless connection.

Mobile 110 may be configured to, when disposed in the cell coverage areas of more than one cell, the cells being comprised in different networks, decide which network to use for attachment or communication. Where mobile 110 is configured to use the first network, it may ignore the presence of the second network. Mobile 110 may be configured to select a certain network by inserting in mobile 110 an identity module issued by an operator of the network. An example of an identity module is a subscriber identity module, SIM. The identity module may comprise authentication information allowing mobile 110 to attach to the network in a secure and/or non-repudiable way to enable charging for services of the network that are accessed via mobile 110. The authentication information may comprise at least one of: at least one certificate, at least one encryption key and at least one token. The at least one encryption key may comprise at least one public, private and/or secret symmetric encryption key.

A subscriber desiring to use a second cellular network, for example where the second cellular network supports a faster data transfer rate, or more favourable pricing, may replace an identity module of a first cellular network with an identity module of the second network, in his mobile. If the mobile is not configured to only accept identity modules of the first network, this can lead to a successful change to the second network. A successful change may entail a changed identity of the subscriber, such as for example a changed telephone number. Where instead the mobile is locked, or exclusive, to the first cellular network, it may be configured to reject an identity module of the second network. In this case, the mobile may be unable to attach to any cellular network until an identity module of the first cellular network is once more placed in it.

The operator of the first cellular network may configure mobiles with exclusivity to the first cellular network, or to a part of the first cellular network, to protect an initial subsidy investment the operator has made to the purchase of the mobiles. Alternatively, the operator may configure such exclusivity to mobiles to prevent the mobiles from attaching to a different segment of the network before security features are enabled in the concerned segment, for example. Alternatively, the operator may configure such exclusivity to mobiles to prevent the mobiles from attaching to a different cellular network that may not yet offer a quality of service the subscriber is expecting.

The exclusivity configured may be configured as limited in time. In some countries it may be illegal to sell mobiles with unlimited exclusivity. In some cases a subscriber is subscribed to receive a defined service for a limited duration, after which the mobile is to remain property of the subscriber. Exclusivity may be 12, 24 or 36 months in duration, for example. After the exclusivity period expires, the subscriber may return the phone to a service point of the operator for having the exclusivity disabled, or the subscriber may request and receive an unlocking code, which may be specific to the mobile, for disabling the exclusivity himself by entering the code into the mobile. In general, the operator may be required to store a database of unlocking codes, wherein the operator must retrieve from the database the unlocking codes one by one as subscribers request them. The database may be securely stored and operated, since subscribers may have an interest in unlocking their mobiles early and misuse may need to be prevented. Alternatively to a database, mobiles may be furnished with capability to derive, using an algorithm, the unlocking code, for example based at least in part on at least one of a country code, an operator code and a device ID. In these cases, the operator may derive upon request the unlocking code for the subscriber by using the algorithm. The mobile may in these cases derive the unlocking code and compare it to an unlocking code input by the subscriber, to determine whether to disable the exclusivity.

Each mobile may be configured with an unlocking code, which the mobile may compare to any unlocking code entered by a subscriber or maintenance employee of the operator. Configuring mobiles with unlocking codes may also be done in a secure manner to prevent abuse. In case of a match, the mobile may be caused to disable the exclusivity. In case of mismatch between an entered unlocking code and a stored unlocking code, the mobile may be configured to increment an internal count of unsuccessful unlocking attempts.

In order to simplify handling of exclusivity, a mobile may be furnished with a timer feature. In connection with establishing a new subscription, an agreed exclusivity period, for example of a length of 12, 24 or 36 months, the mobile may be enabled to autonomously disable the exclusivity after the exclusivity period expires, or at the expiry of the exclusivity period. In this way, there is no need to manage unlocking codes and a subscriber needn't bring his mobile to a service point, or request and input an unlocking code. In some embodiments, a mobile is configured to inform the subscriber via a user interface message of the expiry of the exclusivity period. The subscriber will then know that he can subsequently use identity modules of different operators.

The timer feature may be comprised in a secure execution environment of the mobile, to prevent a subscriber from tampering with the exclusivity feature. The exclusivity period may be configured into the timer feature at the factory where the mobile is assembled, or alternatively the operator may be enabled to initialize or modify the exclusivity period. The operator may be enabled to initialize or modify the exclusivity period, before a first subscriber takes the mobile into use, for example by using a near-field or short-range wireless connection with the mobile. This way, the operator may initialize, modify or verify the exclusivity period without removing the mobile from its packaging. The exclusivity feature may be configured with an identity of a network of the operator likewise at the factory, or by the operator as described above. Once in possession of the identity of the network, the exclusivity feature can identify which identity modules it should accept and which to reject, based on the network identity. Alternatively to a wireless connection, the operator may use a wire-line interface with the mobile to configure the network identity and/or exclusivity period.

The timer feature may be configured to store, as part of an initial setup procedure where the subscriber initially powers on the device on having removed it from its packaging, at least one of a current date and an exclusivity end date determined from the current date and the exclusivity period. Subsequently, where a current date is stored, the timer feature may be configured to determine whether a difference between a current date and the date stored as part of the initial setup procedure corresponds to the exclusivity period, to determine whether to disable the exclusivity feature. Alternatively, where an exclusivity end date is stored, the timer feature may determine whether the current date has advanced to at least the exclusivity end date. The current date may exceed the exclusivity end date in case the mobile has been switched off on the exact date the exclusivity period expired.

The timer feature may be configured to store a count of days, weeks or months corresponding to the exclusivity period, and subsequently to subtract from the count as days, weeks or months go by, and to eventually disable the exclusivity feature responsive to the count reaching zero.

The timer feature may be configured to transmit an initialization signal to the operator in connection with the initial setup, and to subsequently receive a signal from the operator indicating that the exclusivity period has expired. In some embodiments, in some cases, an exclusivity period can be ended prematurely upon agreement to that effect between the subscriber and the operator, for example where the subscriber at least in part returns a subsidy paid by the operator or where network upgrading has progressed faster than planned. In those cases, the subscriber may bring the mobile to a service point for exclusivity feature disabling, or the subscriber may request an unlocking code from the operator. Overall embodiments of the present invention do not necessarily preclude use of alternative ways for disabling the exclusivity. Rather, for example, a customer service point of an operator can remain capable of deriving an unlock code to disable the exclusivity, as described above. In some cases, an operator may transmit a command, or instruction, via a cellular network to at least one, and up to all, mobiles 110, of the network, instructing the at least one mobile 110 to disable the exclusivity.

In general there is provided an apparatus, such as for example a mobile 110, the apparatus comprising a memory configured to store a time parameter defining a locking period. The locking period may comprise an exclusivity period. The locking period may comprise a locking time period. The memory may comprise magnetic, flash and/or secured memory, for example. The apparatus may further comprise processing circuitry, such as for example at least one processing core or other execution-capable circuitry. The processing circuitry may be configured to determine, using the time parameter, whether the locking period has elapsed. The determination may comprise, for example, a comparison involving a current time and the time parameter. The processing circuitry may be further configured to, responsive to a determination that the locking period has elapsed, cause a locking feature to be disabled. The locking feature may, when enabled, be configured to restrict use of the apparatus to use with identity modules of a first type, such as for example those of a certain operator. The locking feature may alternatively comprise a feature to disable a capability of the apparatus, such as an internet access capability.

In some embodiments, the time parameter comprises at least one of a length of time and an end time. An end time may comprise an end date. The processing circuitry may be configured to obtain a current time from a network for comparing with the time parameter.

In some embodiments, the processing circuitry is configured to begin the locking period as part of an initial setup procedure of the apparatus. An initial setup procedure may comprise the apparatus determining that it is being activated by an end user for the first time. The initial setup procedure may comprise a first registration to a network. Responsive to the first registration to a network, the apparatus may begin the locking period and set a state variable to indicate that this has been done. The initial setup procedure may comprise prompting a user to generate an identity, or account, with the apparatus for subsequent usage.

In some embodiments, the locking feature is enabled during the locking period, for example the locking feature may be set to an enabled state in connection with beginning the locking period. In some embodiments, the processing circuitry is comprised in a secure processing environment, such as for example a processing environment also hosting a BB5 based SIMv3 system. In some embodiments, the processing circuitry is configured to, responsive to receiving a signaling message, disable the locking feature before the locking feature has elapsed. For example, the subscriber and operator may agree to end the locking feature early, for example due to earlier than expected upgrading of technical capabilities in at least one network.

In some embodiments, the apparatus comprises a receiver configured to receive the time parameter from a network. The receiver may comprise a near-field or low-power wireless receiver, or a receiver operationally connected to such a receiver. The receiver may comprise a cellular receiver, or a receiver operationally connected to such a receiver. The network may correspondingly comprise a near-field, low-power or cellular network, respectively.

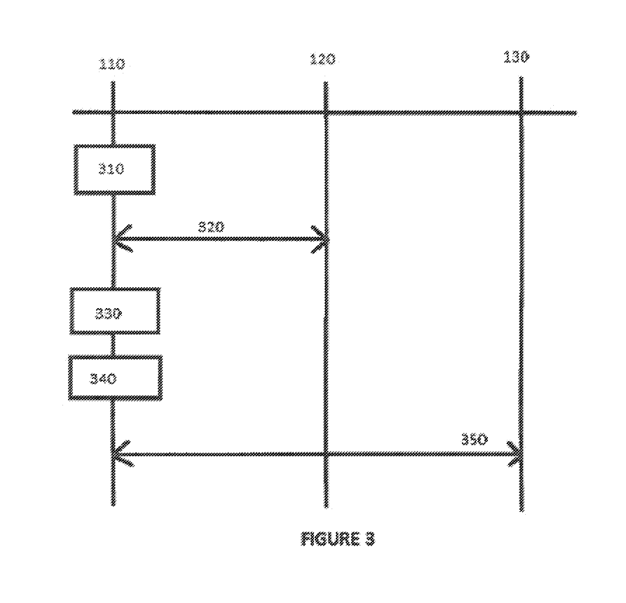

FIG. 3 is a signaling diagram illustrating signaling in accordance with at least one embodiment of the invention. On the vertical axes are, from left or right, mobile 110, base station 120 and base station 130 of FIG. 1. Time advances from top to bottom. In phase 310, for example as part of an initial setup procedure, a locking period is initialized in mobile 110. The locking period may limit use of mobile 110 to use with identity modules of a first operator, who operates a first network in which base station 120 is comprised. In phase 320, mobile 110 communicates with base station 120 to obtain services via the first network. During phase 320, the locking period is on-going and a locking feature in mobile 110 is active. The services may comprise, for example, voice telephony or file sharing. In phase 330, it is determined in mobile 110 that the locking period has elapsed, and responsively the locking feature in mobile 110 is disabled. A message may be displayed to the user of mobile 110 informing him of the disabling of the locking feature. The status of the locking feature may also be discernible via a menu of a user interface of mobile 110. In phase 340, knowing the locking feature is disabled, the user may replace, in mobile 110, an identity module of the first operator with an identity module of a second operator. The second operator operates a second network in which base station 130 is comprised. In phase 350, using the identity mobile of the second operator, mobile 110 accesses services via base station 130 and the second network.

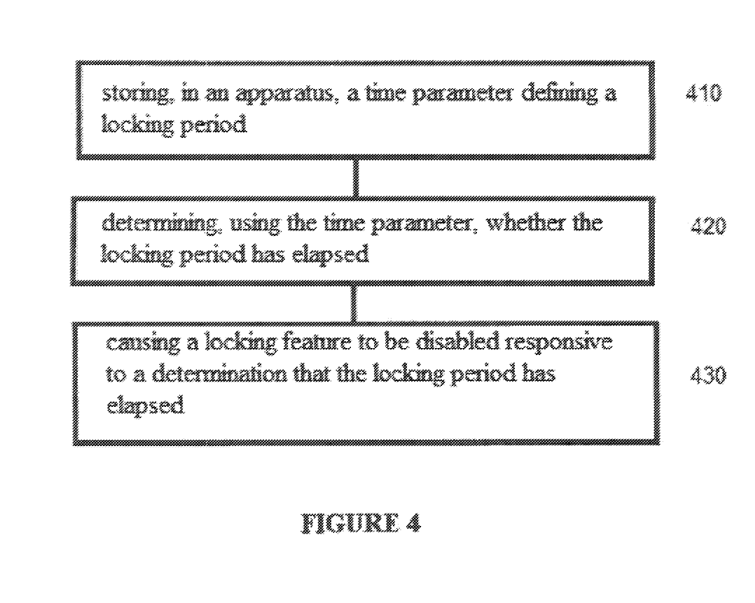

FIG. 4 is a flow diagram illustrating a method in accordance with at least some embodiments of the invention. The phases of the illustrated method may be performed in mobile 110, for example. Phase 410 comprises storing, in an apparatus, a time parameter defining a locking period. The locking period may comprise a locking time period, for example. Phase 420 comprises determining, using the time parameter, whether the locking period has elapsed. Phase 430 comprises causing a locking feature to be disabled responsive to a determination that the locking period has elapsed. The locking feature may be, when enabled, configured to restrict use of the apparatus to use with identity modules of a first type. The locking feature may be an exclusivity feature.

FIG. 2 illustrates a block diagram of an apparatus 10 such as, for example, a mobile terminal, in accordance with an example embodiment of the invention. While several features of the apparatus are illustrated and will be hereinafter described for purposes of example, other types of electronic devices, such as mobile telephones, mobile computers, portable digital assistants, PDAs, pagers, laptop computers, desktop computers, gaming devices, televisions, routers, home gateways, and other types of electronic systems, may employ various embodiments of the invention.

As shown, the mobile terminal 10 may include at least one antenna 12 in communication with a transmitter 14 and a receiver 16. Alternatively transmit and receive antennas may be separate. The mobile terminal 10 may also include processing circuitry, for example comprised in a processor 20 configured to provide signals to and receive signals from the transmitter and receiver, respectively, and to control the functioning of the apparatus. Processor 20 may be configured to control the functioning of the transmitter and receiver by effecting control signaling via electrical leads to the transmitter and receiver. Likewise processor 20 may be configured to control other elements of apparatus 10 by effecting control signaling via electrical leads connecting processor 20 to the other elements, such as for example a display or a memory. The processor 20 may, for example, be embodied as various means including circuitry, at least one processing core, one or more microprocessors with accompanying digital signal processor(s), one or more processor(s) without an accompanying digital signal processor, one or more coprocessors, one or more multi-core processors, one or more controllers, processing circuitry, one or more computers, various other processing elements including integrated circuits such as, for example, an application specific integrated circuit, ASIC, or field programmable gate array, FPGA, or some combination thereof. Accordingly, although illustrated in FIG. 2 as a single processor, in some embodiments the processor 20 comprises a plurality of processors or processing cores. Signals sent and received by the processor 20 may include signaling information in accordance with an air interface standard of an applicable cellular system, and/or any number of different wireline or wireless networking techniques, comprising but not limited to Wi-Fi, wireless local access network, WLAN, techniques such as Institute of Electrical and Electronics Engineers, IEEE, 802.11, 802.16, and/or the like. In addition, these signals may include speech data, user generated data, user requested data, and/or the like. In this regard, the apparatus may be capable of operating with one or more air interface standards, communication protocols, modulation types, access types, and/or the like. More particularly, the apparatus may be capable of operating in accordance with various first generation, 1G, second generation, 2G, 2.5G, third-generation, 3G, communication protocols, fourth-generation, 4G, communication protocols, Internet Protocol Multimedia Subsystem, IMS, communication protocols, for example, session initiation protocol, SIP, and/or the like. For example, the apparatus may be capable of operating in accordance with 2G wireless communication protocols IS-136, Time Division Multiple Access TDMA, Global System for Mobile communications, GSM, IS-95, Code Division Multiple Access, CDMA, and/or the like. Also, for example, the mobile terminal may be capable of operating in accordance with 2.5G wireless communication protocols General Packet Radio Service. GPRS, Enhanced Data GSM Environment, EDGE, and/or the like. Further, for example, the apparatus may be capable of operating in accordance with 3G wireless communication protocols such as Universal Mobile Telecommunications System, UMTS, Code Division Multiple Access 2000, CDMA2000, Wideband Code Division Multiple Access, WCDMA, Time Division-Synchronous Code Division Multiple Access, TD-SCDMA, and/or the like. The apparatus may be additionally capable of operating in accordance with 3.9G wireless communication protocols such as Long Term Evolution, LTE, or Evolved Universal Terrestrial Radio Access Network, E-UTRAN, and/or the like. Additionally, for example, the apparatus may be capable of operating in accordance with fourth-generation, 4G, wireless communication protocols such as LTE Advanced and/or the like as well as similar wireless communication protocols that may be developed in the future.

Some Narrow-band Advanced Mobile Phone System, NAMPS, as well as Total Access Communication System, TACS, mobile terminal apparatuses may also benefit from embodiments of this invention, as should dual or higher mode phone apparatuses, for example, digital/analogue or TDMA/CDMA/analogue phones. Additionally, apparatus 10 may be capable of operating according to Wi-Fi or Worldwide Interoperability for Microwave Access, WiMAX, protocols.

It is understood that the processor 20 may comprise circuitry for implementing audio/video and logic functions of apparatus 10. For example, the processor 20 may comprise a digital signal processor device, a microprocessor device, an analogue-to-digital converter, a digital-to-analogue converter, and/or the like. Control and signal processing functions of the mobile terminal may be allocated between these devices according to their respective capabilities. The processor may additionally comprise an internal voice coder, VC, 20a, an internal data modem, DM, 20b, and/or the like. Further, the processor may comprise functionality to operate one or more software programs, which may be stored in memory. In general, processor 20 and stored software instructions may be configured to cause apparatus 10 to perform actions. For example, processor 20 may be capable of operating a connectivity program, such as a web browser. The connectivity program may allow the mobile terminal 10 to transmit and receive web content, such as location-based content, according to a protocol, such as wireless application protocol, WAP, hypertext transfer protocol, HTTP, and/or the like

Apparatus 10 may also comprise a user interface including, for example, an earphone or speaker 24, a ringer 22, a microphone 26, a display 28, a user input interface, and/or the like, which may be operationally coupled to the processor 20. In this regard, the processor 20 may comprise user interface circuitry configured to control at least some functions of one or more elements of the user interface, such as, for example, the speaker 24, the ringer 22, the microphone 26, the display 28, and/or the like. The processor 20 and/or user interface circuitry comprising the processor 20 may be configured to control one or more functions of one or more elements of the user interface through computer program instructions, for example, software and/or firmware, stored on a memory accessible to the processor 20, for example, volatile memory 40, non-volatile memory 42, and/or the like. Although not shown, the apparatus may comprise a battery for powering various circuits related to the mobile terminal, for example, a circuit to provide mechanical vibration as a detectable output. The user input interface may comprise devices allowing the apparatus to receive data, such as a keypad 30, a touch display, which is not shown, a joystick, which is not shown, and/or at least one other input device. In embodiments including a keypad, the keypad may comprise numeric 0-9 and related keys, and/or other keys for operating the apparatus.

As shown in FIG. 2, apparatus 10 may also include one or more means for sharing and/or obtaining data. For example, the apparatus may comprise a short-range radio frequency, RF, transceiver and/or interrogator 64 so data may be shared with and/or obtained from electronic devices in accordance with RF techniques. The apparatus may comprise other short-range transceivers, such as, for example, an infrared, IR, transceiver 66, a Bluetooth™′ BT, transceiver 68 operating using Bluetooth™ brand wireless technology developed by the Bluetooth™ Special Interest Group, a wireless universal serial bus, USB, transceiver 70 and/or the like. The Bluetooth™ transceiver 68 may be capable of operating according to low power or ultra-low power Bluetooth™ technology, for example, Wibree™, radio standards. In this regard, the apparatus 10 and, in particular, the short-range transceiver may be capable of transmitting data to and/or receiving data from electronic devices within a proximity of the apparatus, such as within 10 meters, for example. Although not shown, the apparatus may be capable of transmitting and/or receiving data from electronic devices according to various wireless networking techniques, including 6LoWpan, Wi-Fi, Wi-Fi low power, WLAN techniques such as IEEE 802.11 techniques, IEEE 802.15 techniques, IEEE 802.16 techniques, and/or the like.

The apparatus 10 may comprise memory, such as a subscriber identity module, SIM, 38, a removable user identity module, R-UIM, and/or the like, which may store information elements related to a mobile subscriber. In addition to the SIM, the apparatus may comprise other removable and/or fixed memory. The apparatus 10 may include volatile memory 40 and/or non-volatile memory 42. For example, volatile memory 40 may include Random Access Memory, RAM, including dynamic and/or static RAM, on-chip or off-chip cache memory, and/or the like. Non-volatile memory 42, which may be embedded and/or removable, may include, for example, read-only memory, flash memory, magnetic storage devices, for example, hard disks, floppy disk drives, magnetic tape, etc., optical disc drives and/or media, non-volatile random access memory, NVRAM, and/or the like. Like volatile memory 40, non-volatile memory 42 may include a cache area for temporary storage of data. At least part of the volatile and/or non-volatile memory may be embedded in processor 20. The memories may store one or more software programs, instructions, pieces of information, data, and/or the like which may be used by the apparatus for performing functions of the mobile terminal. For example, the memories may comprise an identifier, such as an international mobile equipment identification, IMEI, code, capable of uniquely identifying apparatus 10.

Without in any way limiting the scope, interpretation, or application of the claims appearing below, a technical effect of one or more of the example embodiments disclosed herein is that management of mobiles is simplified as unlock code databases can be eliminated. Another technical effect of one or more of the example embodiments disclosed herein is that management of mobiles is simplified as communication of an unlock code is made unnecessary. Another technical effect of one or more of the example embodiments disclosed herein is that timing mobiles to be allowed access to network sections can be planned to co-incide with planned network upgrades.

Embodiments of the present invention may be implemented in software, hardware, application logic or a combination of software, hardware and application logic. The software, application logic and/or hardware may reside on memory 40, the control apparatus 20 or electronic components, for example. In an example embodiment, the application logic, software or an instruction set is maintained on any one of various conventional computer-readable media. In the context of this document, a “computer-readable medium” may be any media or means that can contain, store, communicate, propagate or transport the instructions for use by or in connection with an instruction execution system, apparatus, or device, such as a computer, with one example of a computer described and depicted in FIG. 2. A computer-readable medium may comprise a computer-readable non-transitory storage medium that may be any media or means that can contain or store the instructions for use by or in connection with an instruction execution system, apparatus, or device, such as a computer. The scope of the invention comprises computer programs configured to cause methods according to embodiments of the invention to be performed.

If desired, the different functions discussed herein may be performed in a different order and/or concurrently with each other. Furthermore, if desired, one or more of the above-described functions may be optional or may be combined.

Although various aspects of the invention are set out in the independent claims, other aspects of the invention comprise other combinations of features from the described embodiments and/or the dependent claims with the features of the independent claims, and not solely the combinations explicitly set out in the claims.

It is also noted herein that while the above describes example embodiments of the invention, these descriptions should not be viewed in a limiting sense. Rather, there are several variations and modifications which may be made without departing from the scope of the present invention as defined in the appended claims.

1-23. (canceled)

24. An apparatus, comprising:
a memory configured to store a time parameter defining a locking period;
processing circuitry configured to determine, using the time parameter, whether the locking period has elapsed;
the processing circuitry being further configured to, responsive to a determination that the locking period has elapsed, cause a locking feature to be disabled,
wherein the locking feature is, when enabled, configured to restrict use of the apparatus to use with identity modules of a first type.

25. An apparatus according to claim 24, wherein the time parameter comprises at least one of a length of time and an end time.

26. An apparatus according to claim 25, wherein the end time comprises an end date.

27. An apparatus according to claim 24, wherein the processing circuitry is further configured to begin the locking period as part of an initial setup procedure of the apparatus.

28. An apparatus according to claim 24, wherein the locking feature is enabled during the locking period.

29. An apparatus according to claim 24, wherein the processing circuitry is comprised in a secure processing environment in the apparatus.

30. An apparatus according to claim 24, wherein the processing circuitry is configured to, responsive to receiving a signaling message, disable the locking feature before the locking period has elapsed.

31. An apparatus according to claim 24, wherein the apparatus comprises a receiver configured to receive the time parameter from a network.

32. An apparatus according to claim 24, wherein the identity modules of a first type comprise cellular subscriber identity modules of a first operator.

33. An apparatus according to claim 24, wherein the apparatus comprises a mobile communication device, the apparatus further comprising an antenna coupled to a radio receiver and configured to provide signals to a signal processor comprised in the mobile communication device.

34. A method, comprising:
storing, in an apparatus, a time parameter defining a locking period;
determining, using the time parameter, whether the locking period has elapsed;
causing a locking feature to be disabled responsive to a determination that the locking period has elapsed,
wherein the locking feature is, when enabled, configured to restrict use of the apparatus to use with identity modules of a first type.

35. A method according to claim 34, wherein the time parameter comprises at least one of a length of time and an end time.

36. A method according to claim 35, wherein the end time comprises an end date.

37. A method according to claim 34, further comprising beginning the locking period as part of an initial setup procedure of the apparatus.

38. A method according to claim 34, wherein the locking feature is enabled during the locking period.

39. A method according to claim 34, wherein the determining is performed in a secure processing environment in the apparatus.

40. A method according to claim 34, further comprising disabling, responsive to receiving a signaling message, the locking feature before the locking period has elapsed.

41. A method according to claim 34, further comprising receiving the time parameter from a network.

42. A method according to claim 34, wherein the identity modules of a first type comprise cellular subscriber identity modules of a first operator.

43. A computer program product comprising a non-transitory computer-readable medium bearing computer program code embodied therein for use with a computer, the computer program code comprising:
code for storing, in an apparatus, a time parameter defining a locking period;
code for determining, using the time parameter, whether the locking period has elapsed;
code for causing a locking feature to be disabled responsive to a determination that the locking period has elapsed,
wherein the locking feature is, when enabled, configured to restrict use of the apparatus to use with identity modules of a first type.
